(19) United States
(12) Patent Application Publication
(10) Pub. No.: US 2007/0293624 A1
(43) Pub. Date: Dec. 20, 2007

(54) HEAT CONDUCTIVE SILICONE GREASE COMPOSITION

(75) Inventors: Nobuaki MATSUMOTO, Annaka-shi (JP); Kei Miyoshi, Annaka-shi (JP); Kunihiro Yamada, Takasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Shin-Etsu Chemical Co., Ltd., Chiyoda-ku (JP)

(21) Appl. No.: 11/763,732

(22) Filed: Jun. 15, 2007

(30) Foreign Application Priority Data
Jun. 16, 2006 (JP) 2006-167893

(51) Int. Cl. C08L 83/04

(52) U.S. Cl. 524/588; 528/35; 525/477; 524/430; 524/424; 524/440

(57) ABSTRACT

Provided is a heat conductive silicone grease composition, including: (A) 100 parts by volume of an organopolysiloxane of a specific structure with a kinematic viscosity at 25° C. within a range from 10 to 100,000 mm²/s, (B) 0.1 to 50 parts by volume of an organopolysiloxane that functions as a wetter and contains a triorganooxysilyl group bonded to one terminal via an alkylene group that may be branched, and (C) 100 to 2,500 parts by volume of a heat conductive filler. The composition exhibits high thermal conductivity, displays excellent initial fluidity and is capable of retaining that fluidity over an extended period, and exhibits excellent heat radiation performance. Heat generated by a heat-generating body can be dissipated into a heat-radiating body by sandwiching the composition between the heat-generating body and the heat-radiating body.

### BACKGROUND OF THE INVENTION

1. Field of the Invention

The present invention relates to a heat conductive silicone grease composition which, even when filled with a large quantity of a heat conductive filler in order to provide superior thermal conductivity, still exhibits favorable handling properties, and also exhibits excellent durability and reliability under conditions of high temperature.

2. Description of the Prior Art

Many electronic components generate heat during use, and in order to ensure that those electronic components function satisfactorily, heat must be conducted away from the electronic components. Particularly in the case of integrated circuit elements such as the CPUs used in personal computers, increases in the operating frequency have lead to increased heat generation, and dealing with this heat has become a significant problem.

Many methods have been proposed for removing this heat. Particularly in the case of electronic components that generate a large quantity of heat, methods have been proposed in which the heat is dissipated by placing a heat conductive material such as a heat conductive grease or heat conductive sheet between the electronic component and another member such as a heat sink (see patent reference 1 and patent reference 2).

Known examples of this type of heat conductive material include heat-radiating greases that comprise a zinc oxide or alumina powder blended into a silicone oil base (see patent reference 3 and patent reference 4).

Moreover, in order to improve the thermal conductivity, many heat conductive materials comprising aluminum nitride powder have been proposed. The above patent reference 1 discloses a thixotropic heat conductive material comprising a liquid organosilicone carrier, silica fiber, and at least one material selected from dendritic zinc oxide, lamellar aluminum nitride and lamellar boron nitride. Patent reference 5 discloses a silicone grease composition obtained by blending a spherical hexagonal aluminum nitride powder with a specified particle size range into a specific organopolysiloxane. Patent reference 6 discloses a heat conductive silicone grease composition that uses a combination of a fine aluminum nitride powder with a small particle size and a coarse aluminum nitride powder with a large particle size. Patent reference 7 discloses a heat conductive silicone grease composition that uses a combination of an aluminum nitride powder and a zinc oxide powder. Patent reference 8 discloses a heat conductive grease composition that uses an aluminum nitride powder that has been surface-treated with an organosilane.

Aluminum nitride has a thermal conductivity of 70 to 270 W/(m·K), whereas diamond has an even higher thermal conductivity of 900 to 2,000 W/(m·K). Patent reference 9 discloses a heat conductive silicone composition that comprises a silicone resin, diamond, zinc oxide, and a dispersant.

Furthermore, metals also have a high thermal conductivity, and can be used in those situations where insulation of the electronic component is unnecessary. Patent reference 10 discloses a heat conductive grease composition obtained by mixing metallic aluminum powder with a base oil such as a silicone oil.

However, none of these heat conductive materials or heat conductive grease compositions is able to satisfactorily cope with the quantity of heat generated by modern integrated circuit elements such as CPUs.

It is known from the theoretical equation of Maxwell and Bruggeman that the thermal conductivity of a material obtained by blending a heat conductive filler into a silicone oil is substantially independent of the thermal conductivity of the heat conductive filler if the volume fraction of the heat conductive filler is 0.6 or less. The thermal conductivity of the material only starts to be affected by the thermal conductivity of the heat conductive filler once the volume fraction of the filler exceeds 0.6. In other words, in order to raise the thermal conductivity of a heat conductive grease composition, the first important factor is to determine how to enable the composition to be filled with a large quantity of heat conductive filler, and if such high-quantity filling is possible, then the next important factor is to determine how to enable the use of a filler with a high thermal conductivity. However, simply increasing the filling quantity can cause a variety of problems, including a marked reduction in the fluidity of the heat conductive grease composition, a deterioration in the workability of the grease composition, including the coating characteristics (such as the dispensing and screen printing characteristics), and an inability of the composition to fill minor indentations within the surface of the electronic component and/or heat sink. In order to resolve these problems, a method has been proposed in which the heat conductive filler is surface-treated with a silane coupling agent (a wetter) and then dispersed within the silicone that functions as the base polymer, thereby enabling the fluidity of the heat conductive grease composition to be maintained.

Examples of wetters that are commonly used include alkoxysilanes (patent reference 11 and patent reference 12). Use of these wetters offers the advantage that the initial viscosity of the heat conductive grease composition can be reduced to an extremely low level. However, because these wetter components gradually volatilize, continued application of heat to the heat conductive grease composition causes the composition to thicken over time, making it impossible to maintain fluidity. Accordingly, in those cases where long term reliability is particularly important, an alkoxy group-containing organopolysiloxane that is resistant to volatilization is used (patent reference 13 and patent reference 14). However, alkoxy group-containing organopolysiloxanes exhibit significantly inferior wetting properties to an equal volume of an alkoxysilane, meaning that heat conductive grease compositions that use an alkoxy group-containing organopolysiloxane as the wetter can not be filled with a large quantity of a heat conductive filler. In other words, in order to produce a heat conductive grease composition with a similar fluidity to that obtained when an alkoxysilane is used, a much larger quantity of the alkoxy group-containing organopolysiloxane is required. If a large quantity of the alkoxy group-containing organopolysiloxane is required in order to fill a certain quantity of a base polymer with a heat conductive filler, then that means that the fill factor for the heat conductive filler must be reduced by a corresponding amount. In other words, currently, the performance of the composition must be sacrificed for the sake of reliability. Accordingly, the development of a wetter which causes no loss in the fluidity of the heat conductive silicone grease composition over time, even if the composition is subjected to continuous heating, which enables the initial viscosity of the composition to be reduced by addition of only a small quantity of the wetter, and which enables the composition to be filled with a large quantity of a heat conductive filler, as well as a heat conductive silicone grease composition that uses such a wetter, have been keenly sought.

[Patent Reference 1] EP 0 024 498 A1

[Patent Reference 2] JP 61-157587 A

[Patent Reference 3] JP 52-33272 B

[Patent Reference 4] GB 1 480 931 A

[Patent Reference 5] JP 2-153995 A

[Patent Reference 6] EP 0 382 188 A1

[Patent Reference 7] U.S. Pat. No. 5,981,641

[Patent Reference 8] U.S. Pat. No. 6,136,758

[Patent Reference 9] JP 2002-30217 A

[Patent Reference 10] US 2002/0018885 A1

[Patent Reference 11] JP 3290127 B2

[Patent Reference 12] JP 3372487 B2

[Patent Reference 13] US 2006/0135687 A1

[Patent Reference 14] JP 2005-162975 A

### SUMMARY OF THE INVENTION

In order to address these problems, an object of the present invention is to provide a heat conductive silicone grease composition that exhibits high thermal conductivity, displays excellent initial fluidity and is capable of retaining that fluidity over an extended period, and exhibits excellent heat radiation performance.

As a result of intensive investigation aimed at achieving the above object, the inventors of the present invention developed a wetter which not only exhibits an improvement in the wetting of a heat conductive filler relative to a silicone that is similar to that of an alkoxysilane, but which when added to a heat conductive silicone grease composition, ensures that the fluidity of the composition is not lost even if the composition is heated continuously over an extended period, and they also discovered that a heat conductive silicone grease composition comprising such a wetter exhibits high thermal conductivity, displays excellent initial fluidity and is capable of retaining that fluidity over an extended period, and exhibits excellent heat radiation performance, and they were therefore able to complete the present invention.

In other words, a first aspect of the present invention provides a heat conductive silicone grease composition, comprising:

(A) 100 parts by volume of an organopolysiloxane with a kinematic viscosity at 25° C. within a range from 10 to 100,000 mm²/s, represented by an average composition formula (1) shown below:

R¹ₐSiO_{(4-a)/2} (1)

(wherein, R¹ represents identical or different, unsubstituted or substituted monovalent hydrocarbon groups of 1 to 18 carbon atoms, and a represents a number within a range from 1.8 to 2.2),

(B) 0.1 to 50 parts by volume of an organosilicon compound represented by a general formula (2) shown below:

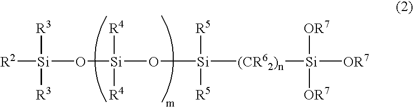

(wherein, R² represents an unsubstituted or substituted alkyl group, alkenyl group or aryl group, each R³ represents, independently, an unsubstituted or substituted alkyl group, alkenyl group or aryl group, R⁴ and R⁵ each represent identical or different unsubstituted or substituted monovalent hydrocarbon groups, each R⁶ represents, independently, a hydrogen atom, or an unsubstituted or substituted monovalent hydrocarbon group, each R⁷ represents, independently, an unsubstituted or substituted alkyl group, alkoxyalkyl group, alkenyl group or acyl group, m represents an integer from 0 to 4, and n represents an integer from 2 to 20), and

(C) 100 to 2,500 parts by volume of a heat conductive filler.

A second aspect of the present invention provides a method for dissipating heat generated by a heat-generating body into a heat-radiating body, comprising the steps of:

applying the above composition to a surface of the heat-generating body, and

mounting the heat-radiating body on the applied composition to sandwich the composition between the heat-generating body and the heat-radiating body, thereby dissipating the heat into the heat-radiating body.

The novel wetter included within the heat conductive silicone grease composition of the present invention not only exhibits an improvement in the wetting of the heat conductive filler relative to the silicone that is similar to that of an alkoxysilane, but also ensures that the fluidity of the composition is not lost even if the composition is heated continuously over an extended period. Accordingly, the heat conductive silicone grease composition of the present invention has excellent thermal conductivity, and because it retains favorable fluidity, also exhibits excellent workability. Furthermore, the composition also exhibits excellent adhesion to heat-generating electronic components and heat-radiating components. Consequently by positioning the heat conductive silicone grease composition of the present invention between a heat-generating electronic component and a heat-radiating component, the heat generated by the heat-generating electronic component can be dissipated efficiently into the heat-radiating component. In addition, the heat conductive silicone grease composition of the present invention exhibits excellent durability under conditions of high temperature, meaning it offers extremely favorable reliability when used for heat dissipation from general power sources or electronic equipment or the like, or for heat dissipation from integrated circuit elements such as LSI and CPU elements used in electronic equipment including personal computers and digital video disc drives. Using a heat conductive silicone grease composition of the present invention enables dramatic improvements in the stability and lifespan of heat-generating electronic components and electronic equipment that uses such components.

### DETAILED DESCRIPTION OF THE PREFERRED EMBODIMENTS

A more detailed description of the present invention is presented below. In the present invention, quantities expressed using the units “parts by volume”, viscosity values, and kinematic viscosity values all refer to values measured at 25° C. Furthermore, “Me” represents a methyl group.

### [Component (A)]

The component (A) is an organopolysiloxane with a kinematic viscosity at 25° C. within a range from 10 to 100,000 mm²/s, represented by an average composition formula (1) shown below:

R¹ₐSiO_{(4-a)/2} (1)

(wherein, R¹ represents identical or different, unsubstituted or substituted monovalent hydrocarbon groups of 1 to 18 carbon atoms, and a represents a number within a range from 1.8 to 2.2).

The component (A) functions as a viscosity regulator for the heat conductive silicone grease composition of the present invention, and imparts the composition with favorable adhesive properties, although the functions of the component (A) are not limited to these functions. The component (A) may use either a single compound, or a combination of two or more different compounds.

R¹ represents identical or different, unsubstituted or substituted monovalent hydrocarbon groups of 1 to 18 carbon atoms. Suitable examples of R¹ include alkyl groups such as a methyl group, ethyl group, propyl group, isopropyl group, butyl group, t-butyl group, pentyl group, hexyl group, octyl group, decyl group, dodecyl group, tetradecyl group, hexadecyl group, or octadecyl group; cycloalkyl groups such as a cyclopentyl group or cyclohexyl group; alkenyl groups such as a vinyl group, allyl group or butenyl group; aryl groups such as a phenyl group, tolyl group, xylyl group or naphthyl group; aralkyl groups such as a benzyl group, 2-phenylethyl group or 2-methyl-2-phenylethyl group; and halogenated hydrocarbon groups such as a chloromethyl group, bromoethyl group, 3,3,3-trifluoropropyl group, 2-(perfluorobutyl)ethyl group, 2-(perfluorooctyl)ethyl group, or p-chlorophenyl group. Of these, a methyl group, phenyl group, or alkyl group of 6 to 18 carbon atoms is particularly preferred.

From the viewpoint of ensuring that the composition of the present invention has the consistency required to function as a silicone grease composition, a preferably represents a number within a range from 1.8 to 2.2, and is even more preferably a number from 1.9 to 2.1.

Furthermore, the kinematic viscosity of the component (A) at 25° C. is typically within a range from 10 to 100,000 mm²/s, and is preferably from 10 to 10,000 mm²/s. If this kinematic viscosity is lower than 10 mm²/s, then the resulting silicone grease composition tends to be more prone to oil bleeding. If the kinematic viscosity exceeds 100,000 mm²/s, then the fluidity of the resulting silicone grease composition tends to deteriorate.

Specific examples of the component (A) include the compounds shown below.

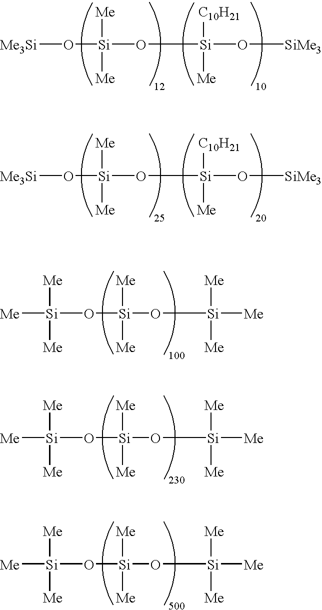

### [Component (B)]

The component (B) is an organosilicon compound represented by a general formula (2) shown below:

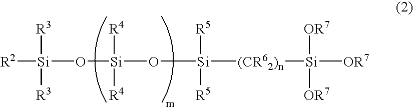

(wherein, R² represents an unsubstituted or substituted alkyl group, alkenyl group or aryl group, each R³ represents, independently, an unsubstituted or substituted alkyl group, alkenyl group or aryl group, R⁴ and R⁵ each represent identical or different unsubstituted or substituted monovalent hydrocarbon groups, each R⁶ represents, independently, a hydrogen atom, or an unsubstituted or substituted monovalent hydrocarbon group, each R⁷ represents, independently, an unsubstituted or substituted alkyl group, alkoxyalkyl group, alkenyl group or acyl group, m represents an integer from 0 to 4, and n represents an integer from 2 to 20).

The component (B) functions as a wetter component for the heat conductive silicone grease composition of the present invention. When added to a heat conductive silicone grease composition, this novel wetter enables the fluidity of the composition to be retained more favorably than the case in which an alkoxysilane is added to a heat conductive silicone grease composition, even if the composition is exposed to high temperatures over an extended period. Furthermore, the wetter is also resistant to freezing even at very low temperatures (for example, −30° C.). Moreover, compared with organosilicon compounds of the general formula (2) in which m is 5 or greater, the wetter of the present invention exhibits a significantly superior improvement in the wetting of the filler relative to the silicone. In other words, whereas existing alkoxy group-containing organopolysiloxanes reduce the fill factor for the heat conductive filler, and must be added in large quantities to enable the fluidity of the heat conductive silicone grease composition to be maintained, the wetter of the component (B) enables the fluidity of resulting composition to be maintained with only the addition of a parts by volume quantity of the component (B) similar to the quantity required of an alkoxysilane. The component (B) may use either a single compound, or a combination of two or more different compounds.

In the above general formula (2), R² represents an unsubstituted or substituted alkyl group, alkenyl group or aryl group that preferably contains from 6 to 30 carbon atoms, and even more preferably from 8 to 20, and most preferably from 10 to 16, carbon atoms. If the number of carbon atoms of R² is within this range, then the effect of the resulting organosilicon compound in improving the wetting of the filler relative to the silicone manifests readily, and handling is favorable because the organosilicon compound is resistant to solidification even at low temperatures (for example, −40° C. to −20° C.). Specific examples of R² include alkyl groups such as a hexyl group, heptyl group, octyl group, nonyl group, decyl group, dodecyl group, tetradecyl group, hexadecyl group, octadecyl group or eicosyl group; alkenyl groups such as a hexenyl group, heptenyl group, octenyl group, nonenyl group, decenyl group, dodecenyl group or tetradecenyl group; aryl groups such as a phenyl group, tolyl group, xylyl group or naphthyl group; and groups in which a portion of, or all of, the hydrogen atoms bonded to carbon atoms in the above hydrocarbon groups have been substituted with halogen atoms or the like such as fluorine, bromine or chlorine atoms, such as a 2-(nonafluorobutyl)ethyl group, 2-(heptadecafluorooctyl)ethyl group or p-chlorophenyl group.

In the above general formula (2), each R³ represents, independently, an unsubstituted or substituted group, which is preferably an alkyl group or alkenyl group of 1 to 8 carbon atoms or an aryl group of 6 to 8 carbon atoms, is even more preferably an alkyl group or alkenyl group of 1 to 5 carbon atoms, and is most preferably an alkyl group or alkenyl group of 1 to 3 carbon atoms. Specific examples of R³ include alkyl groups such as a methyl group, ethyl group, propyl group, isopropyl group, butyl group, t-butyl group, pentyl group, hexyl group or octyl group; alkenyl groups such as a vinyl group, allyl group or butenyl group; aryl groups such as a phenyl group, tolyl group or xylyl group; and groups in which a portion of, or all of, the hydrogen atoms bonded to carbon atoms in the above hydrocarbon groups have been substituted with halogen atoms or the like such as fluorine, bromine or chlorine atoms, such as a chloromethyl group, bromoethyl group, 3,3,3-trifluoropropyl group, 2-(nonafluorobutyl)ethyl group or p-chlorophenyl group. Of these possibilities, from the viewpoints of ease of synthesis of the organosilicon compound of the component (B) and economic viability, a methyl group or ethyl group is particularly preferred.

In the above general formula (2), R⁴ and R⁵ each represent identical or different unsubstituted or substituted, saturated or unsaturated, monovalent hydrocarbon groups that preferably contain from 1 to 8 carbon atoms, and even more preferably from 1 to 5, and most preferably from 1 to 3, carbon atoms. Specific examples of R⁴ and R⁵ include alkyl groups such as a methyl group, ethyl group, propyl group, isopropyl group, butyl group, t-butyl group, pentyl group, hexyl group or octyl group; cycloalkyl groups such as a cyclopentyl group or cyclohexyl group; alkenyl groups such as a vinyl group, allyl group or butenyl group; aryl groups such as a phenyl group, tolyl group or xylyl group; aralkyl groups such as a benzyl group or 2-phenylethyl group; and groups in which a portion of, or all of, the hydrogen atoms bonded to carbon atoms in the above hydrocarbon groups have been substituted with halogen atoms or the like such as fluorine, bromine or chlorine atoms, including halogenated monovalent hydrocarbon groups such as a chloromethyl group, bromoethyl group, 3,3,3-trifluoropropyl group, 2-(nonafluorobutyl)ethyl group or p-chlorophenyl group. Of these possibilities, from the viewpoints of ease of synthesis of the organosilicon compound of the component (B) and economic viability, a methyl group or ethyl group is particularly preferred.

In the above general formula (2), each R⁶ group represents, independently, a hydrogen atom, or an unsubstituted or substituted monovalent hydrocarbon group that preferably contains from 1 to 5 carbon atoms, and even more preferably from 1 to 3, and most preferably from 1 to 2, carbon atoms. In those cases where R⁶ is a monovalent hydrocarbon group, specific examples of suitable groups include alkyl groups such as a methyl group, ethyl group, propyl group, isopropyl group, butyl group, t-butyl group or pentyl group; cycloalkyl groups such as a cyclopentyl group; alkenyl groups such as a vinyl group, allyl group or butenyl group; and groups in which a portion of, or all of, the hydrogen atoms bonded to carbon atoms in the above hydrocarbon groups have been substituted with halogen atoms or the like such as fluorine, bromine or chlorine atoms, such as a chloromethyl group, bromoethyl group or 3,3,3-trifluoropropyl group. Of these possibilities, from the viewpoints of ease of synthesis of the organosilicon compound of the component (B) and economic viability, R⁶ is most preferably a hydrogen atom.

In the above general formula (2), each R⁷ represents, independently, an unsubstituted or substituted alkyl group, alkoxyalkyl group, alkenyl group or acyl group, that preferably contains from 1 to 6, even more preferably from 1 to 4, and most preferably from 1 to 3, carbon atoms. In those cases where R⁷ is an alkyl group, specific examples of suitable groups include alkyl groups such as a methyl group, ethyl group, propyl group, isopropyl group, butyl group, t-butyl group, pentyl group or hexyl group; and groups in which a portion of, or all of, the hydrogen atoms bonded to carbon atoms within the above alkyl groups have been substituted with halogen atoms or the like such as fluorine, bromine or chlorine atoms, such as a chloromethyl group, bromoethyl group, 3,3,3-trifluoropropyl group or 2-(nonafluorobutyl)ethyl group. Furthermore, in those cases where R⁷ is an alkoxyalkyl group, specific examples of suitable groups include alkoxyalkyl groups such as a methoxyethyl group, methoxypropyl group, ethoxyethyl group or butoxyethyl group; and groups in which a portion of, or all of, the hydrogen atoms bonded to carbon atoms within these alkoxyalkyl groups have been substituted with halogen atoms or the like such as fluorine, bromine or chlorine atoms. In those cases where R⁷ is an alkenyl group, specific examples of suitable groups include alkenyl groups such as a vinyl group, allyl group or butenyl group; and groups in which a portion of, or all of, the hydrogen atoms bonded to carbon atoms within these alkenyl groups have been substituted with halogen atoms or the like such as fluorine, bromine or chlorine atoms. Moreover, in those cases where R⁷ is an acyl group, specific examples of suitable groups include acyl groups such as an acetyl group, propionyl group, acryloyl group or methacryloyl group; and groups in which a portion of, or all of, the hydrogen atoms bonded to carbon atoms within these acyl groups have been substituted with halogen atoms or the like such as fluorine, bromine or chlorine atoms. Of these possibilities, from the viewpoints of ease of synthesis of the organosilicon compound of the component (B) and economic viability, a methyl group or ethyl group is particularly preferred.

In the above general formula (2), m is typically an integer from 0 to 4, and is preferably from 0 to 3, and even more preferably from 0 to 2. From the viewpoints of ease of synthesis of the organosilicon compound of the component (B) and economic viability, m is most preferably an integer from 0 to 1. Furthermore, in the above general formula (2), n is typically an integer from 2 to 20, although from the viewpoints of ease of synthesis of the organosilicon compound of the component (B) and economic viability, n is preferably within a range from 2 to 10, and is most preferably 2.

Specific examples of the organosilicon compound represented by the general formula (2) include the compounds shown below, although the present invention is not restricted to the compounds shown below.

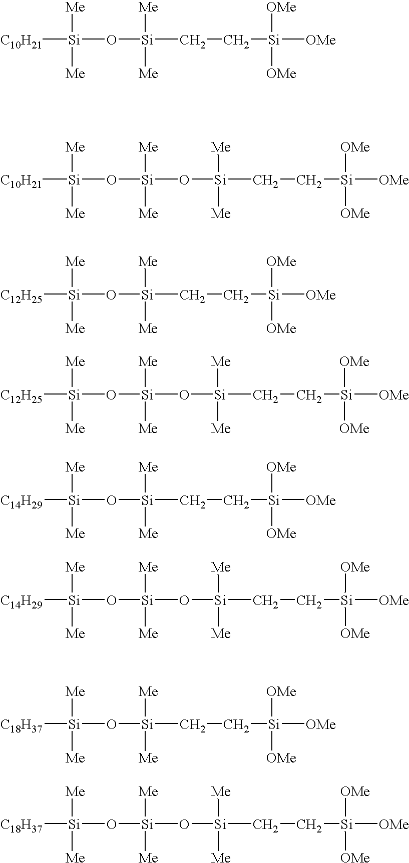

The quantity added of the component (B) is typically within a range from 0.1 to 50 parts by volume, and preferably from 1 to 20 parts by volume, per 100 parts by volume of the component (A). If the quantity of the component (B) is within this range, then the wetting effect and the resistance to high temperature can be easily improved by increasing the quantity of the component (B), which is desirable from an economic viewpoint. On the other hand, the component (B) exhibits a certain degree of volatility, and consequently if a heat conductive silicone grease composition containing the component (B) is left to stand within an open system, then the component (B) may gradually evaporate from the composition, causing the composition to gradually harden. However, if the quantity of the component (B) is within the above range, then this type of evaporation phenomenon can be more readily suppressed.

An organosilicon compound of the general formula (2) can be produced, for example, using the methods described below.

In a first method, the organosilicon compound is produced using a method that includes a step represented by the reaction formula (A) shown below.

### Reaction Formula (A):

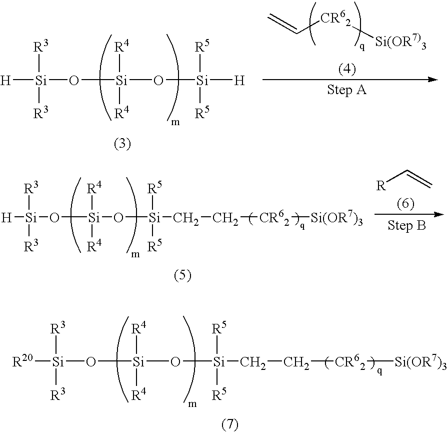

(wherein, R³ to R⁷, and m are as defined above; R represents an unsubstituted or substituted alkyl group or alkenyl group that preferably contains from 4 to 28 carbon atoms, and even more preferably from 6 to 18, and most preferably from 8 to 14, carbon atoms; R²⁰ represents an unsubstituted or substituted alkyl group or alkenyl group represented by R—CH₂—CH₂— that preferably contains from 6 to 30 carbon atoms, and even more preferably from 8 to 20, and most preferably from 10 to 16, carbon atoms; and q represents either 0 or 1)

### <Step A>

By reacting an organohydrogensiloxane (3) with a vinylsilane (4) in the presence of a hydrosilylation catalyst, a diorganohydrogensiloxy-mono-terminated organosiloxane (5) is synthesized.

This reaction may be conducted without a solvent. Alternatively, the reaction may be conducted in the presence of a solvent such as toluene. The reaction temperature is typically within a range from 70 to 100° C., and is preferably from 70 to 90° C. The reaction time is typically from 1 to 3 hours. In this reaction, the quantity added of the vinylsilane (4) is preferably within a range from 0.5 to 1.0 mols, and even more preferably from 0.5 to 0.6 mols, per 1 mol of the organohydrogensiloxane (3).

### <Step B>

By reacting the diorganohydrogensiloxy-mono-terminated organosiloxane (5) with an alkene (6) in the presence of a hydrosilylation catalyst, an organosilicon compound (7) is obtained.

The reaction temperature is typically within a range from 70 to 100° C., and is preferably from 70 to 90° C. The reaction time is typically from 1 to 3 hours. In this reaction, the quantity added of the alkene (6) is preferably within a range from 1.0 to 2.0 mols, and even more preferably from 1.0 to 1.5 mols, per 1 mol of the diorganohydrogensiloxy-mono-terminated organosiloxane (5).

Specific examples of the group R include alkyl groups such as a butyl group, pentyl group, hexyl group, heptyl group, octyl group, nonyl group, decyl group, dodecyl group, tetradecyl group, hexadecyl group or octadecyl group; alkenyl groups such as a butenyl group, pentenyl group, hexenyl group, heptenyl group, octenyl group, nonenyl group, decenyl group, dodecenyl group or tetradecenyl group; aryl groups such as a phenyl group, tolyl group, xylyl group or naphthyl group; and groups in which a portion of, or all of, the hydrogen atoms bonded to carbon atoms within these hydrocarbon groups have been substituted with halogen atoms or the like such as fluorine, bromine or chlorine atoms, such as a 2-(nonafluorobutyl)ethyl group, 2-(heptadecafluorooctyl)ethyl group or p-chlorophenyl group.

In a second method, the organosilicon compound is produced using a method that includes a step represented by the reaction formula (B) shown below.

### Reaction Formula (B):

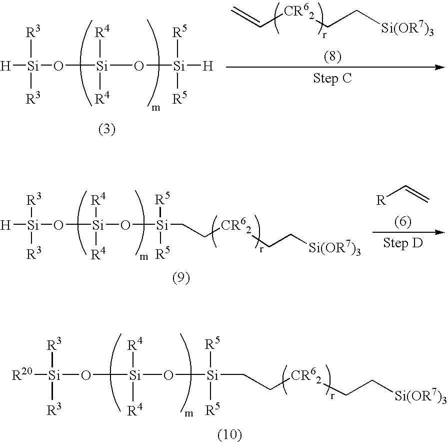

(wherein, R³ to R⁷, R²⁰, R and m are as defined above; and r represents an integer from 0 to 16)

### <Step C>

By reacting an organohydrogensiloxane (3) with an alkenyltriorganooxysilane (8) in the presence of a hydrosilylation catalyst, a diorganohydrogensiloxy-mono-terminated organosiloxane (9) is synthesized.

This reaction may be conducted without a solvent. Alternatively, the reaction may be conducted in the presence of a solvent such as toluene. The reaction temperature is typically within a range from 70 to 100° C., and is preferably from 70 to 90° C. The reaction time is typically from 1 to 3 hours. In this reaction, the quantity added of the alkenyltriorganooxysilane (8) is preferably within a range from 0.5 to 1.0 mols, and even more preferably from 0.5 to 0.6 mols, per 1 mol of the organohydrogensiloxane (3).

### <Step D>

By reacting the diorganohydrogensiloxy-mono-terminated organosiloxane (9) with an alkene (6) in the presence of a hydrosilylation catalyst, an organosilicon compound (10) is obtained.

The reaction temperature is typically within a range from 70 to 100° C., and is preferably from 70 to 90° C. The reaction time is typically from 1 to 3 hours. In this reaction, the quantity added of the alkene (6) is preferably within a range from 1.0 to 2.0 mols, and even more preferably from 1.0 to 1.5 mols, per 1 mol of the diorganohydrogensiloxy-mono-terminated organosiloxane (9).

Examples of methods of producing the raw material alkenyltriorganooxysilane (8) include methods that include a step represented by the reaction formula (C) shown below.

### Reaction Formula (C):

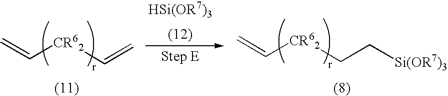

(wherein, R⁶, R⁷, and r are as described above)

### <Step E>

By reacting a diene (11) and a triorganooxysilane (12) in the presence of a hydrosilylation catalyst, an alkenyltriorganooxysilane (8) is synthesized. This reaction may be conducted without a solvent. Alternatively, the reaction may be conducted in the presence of a solvent such as toluene. The reaction temperature is typically within a range from 70 to 100° C., and is preferably from 70 to 90° C. The reaction time is typically from 1 to 3 hours. In this reaction, the quantity added of the triorganooxysilane (12) is preferably within a range from 0.5 to 1.0 mols, and even more preferably from 0.5 to 0.6 mols, per 1 mol of the diene (11).

### <Hydrosilylation Catalyst>

The hydrosilylation catalyst used in each of the steps described above is a catalyst for accelerating the addition reaction between the aliphatic unsaturated group (alkenyl group or diene group or the like) within one of the raw material compounds, and the silicon atom-bonded hydrogen atom (namely, SiH group) within the other raw material compound. Examples of the hydrosilylation catalyst include platinum group metal-based catalysts such as simple platinum group metals, and compounds thereof. Conventional platinum group metal-based catalysts can be used, and specific examples include fine particles of platinum metal adsorbed to a carrier such as silica, alumina or silica gel, platinic chloride, chloroplatinic acid, an alcohol solution of chloroplatinic acid hexahydrate, as well as palladium catalysts and rhodium catalysts, although of these, compounds that contain platinum as the platinum group metal are preferred. The hydrosilylation catalyst may use either a single material, or a combination of two or more different materials.

The quantity added of the hydrosilylation catalyst need only be sufficient to enable effective acceleration of the aforementioned addition reactions, and a typical quantity, calculated as a mass of the platinum group metal relative to the combined mass of the raw material compounds, is within a range from 1 ppm (by mass, this also applies below) to 1% by mass, and a quantity from 10 to 500 ppm is preferred. If the quantity is within this range, then the addition reactions can be accelerated satisfactorily, and the rate of the addition reactions can be easily increased by increasing the quantity of the hydrosilylation catalyst, which is desirable from an economic viewpoint.

### [Component (C)]

The component (C) functions as a heat conductive filler within the heat conductive silicone grease composition of the present invention. The component (C) may use either a single compound, or a combination of two or more different compounds.

The average particle size of the component (C) is preferably within a range from 0.1 to 50 μm, and is even more preferably from 1 to 35 μm. If the average particle size is within this range, then the bulk density of the component (C) can be easily increased, and the specific surface area can be easily reduced, meaning high-quantity filling of the component (C) within the heat conductive silicone grease composition of the present invention can be achieved more easily. If the average particle size is too large, then oil separation may proceed more readily. In the present invention, the average particle size can be determined as a volume-based cumulative average particle size, using a laser diffraction method.

There are no particular restrictions on the shape of the particles of the component (C), and spherical, rod-shaped, needle-like, disc-shaped, scale-like, and irregularly shaped particles are all suitable.

Specific examples of the component (C) include aluminum, silver, copper, nickel, zinc oxide, alumina, silicon oxide, magnesium oxide, aluminum nitride, boron nitride, silicon nitride, silicon carbide, diamond, graphite, carbon nanotubes, metallic silicon, carbon fiber, fullerene, or combinations of two or more of these materials.

The quantity added of the component (C) is typically within a range from 100 to 2,500 parts by volume, and preferably from 150 to 1,500 parts by volume, per 100 parts by volume of the component (A). If this addition quantity is less than 100 parts by volume, then the thermal conductivity of the resulting composition tends to decrease. In contrast, if the total quantity added exceeds 2,500 parts by volume, then the viscosity of the resulting composition tends to become overly high, making the fluidity and handling characteristics of the composition unsatisfactory.

### [Component (D)]

A composition of the present invention may also include, as a component (D), a volatile solvent capable of dissolving or dispersing the components (A) and (B). The component (D) may be any solvent that is capable of dissolving or dispersing the components (A) and (B). The component (D) may use either a single solvent, or a combination of two or more different solvents.

Because the thermal conductivity of the heat conductive silicone grease composition correlates basically with the fill factor of the heat conductive filler, the thermal conductivity increases as the quantity of the heat conductive filler included in the composition is increased. However, as the fill quantity of the heat conductive filler is increased, the viscosity of the heat conductive silicone grease composition tends to increase, and the dilatancy of the composition when a shearing action is applied also tends to strengthen. Particularly in the case of screen printing, if dilatancy manifests strongly during squeegee application of the heat conductive silicone grease composition, then the fluidity of the heat conductive silicone grease composition is temporarily inhibited quite powerfully, meaning the heat conductive silicone grease composition may be unable to pass through the screen mask or screen mesh, causing a deterioration in the coating characteristics at the edges of the mask or mesh. For this reason, conventionally, the use of a screen printing method to apply a uniform thin coating of a highly heat conductive silicone grease composition containing a large fill quantity of a heat conductive filler to a heat sink or the like has been difficult. In the case of a heat conductive silicone grease composition of the present invention, even when the heat conductive filler of the component (C) is included at a very high fill factor, if a volatile solvent of the component (D) is included in the composition, then the viscosity can be drastically reduced, meaning dilatancy is far less likely to occur. As a result, the coating characteristics tend to improve, and application of the composition to a heat sink or the like can be conducted easily using screen printing. Following application, the component (D) can be easily removed by evaporation, either at room temperature, or by heating. Accordingly, by using the present invention, a uniform thin coating of a highly heat conductive silicone grease composition containing a large fill quantity of a heat conductive filler can be applied easily to a heat sink or the like by screen printing.

The boiling point of the component (D) is preferably within a range from 80 to 260° C. If the boiling point is within this range, then the danger of the component (D) evaporating rapidly from the composition during the coating operation can be prevented, meaning increases in the viscosity of the composition can be easily suppressed, and the coating characteristics of the composition can be satisfactorily maintained. Furthermore, the component (D) is unlikely to remain within the composition following the coating operation, meaning the heat-radiating properties of the applied coating can be improved.

Specific examples of the component (D) include toluene, xylene, acetone, methyl ethyl ketone, cyclohexane, n-hexane, n-heptane, butanol, isopropanol (IPA), and isoparaffin-based solvents. Of these, from the viewpoints of safety, health, and workability, isoparaffin-based solvents are preferred, and isoparaffin-based solvents with a boiling point of 80 to 260° C. are particularly desirable.

In those cases where a component (D) is added to the composition of the present invention, the quantity added is preferably not more than 100 parts by volume, and is even more preferably 75 parts by volume or less, per 100 parts by volume of the component (A). If this addition quantity is within this range, then the component (C) can be prevented from undergoing rapid sedimentation, meaning the storage stability of the composition can be improved.

### [Other Additives]

Other additives may also be added to the heat conductive silicone grease composition of the present invention, provided the addition of these other additives does not impair the purpose of the present invention. For example, a feature of the composition of the present invention is its grease-like nature, and consequently additives that impair this grease-like state are not permissible. Examples of these optional components include typically used additives or fillers. Specific examples include fluorine-modified silicone surfactants; colorants such as carbon black, titanium dioxide, and red iron oxide; and flame retardancy-imparting agents such as platinum compounds, metal oxides such as iron oxide, titanium oxide and cerium oxide, and metal hydroxides. Moreover, in order to prevent sedimentation of the heat conductive filler under high-temperature conditions, a finely powdered silica such as a precipitated silica or calcined silica, or a thixotropic improvement agent or the like may also be added.

### [Viscosity]

The viscosity at 25° C. of a heat conductive silicone grease composition of the present invention is preferably not higher than 1,000 Pa·s (namely, from 1 to 1,000 Pa·s), and is even more preferably 500 Pa·s or less (10 to 500 Pa·s). If the viscosity is within this range, then the composition tends to have more favorable fluidity, which improves the workability properties such as the dispensing and screen printing characteristics, and makes it easier to apply a thin coating of the composition to a substrate. The viscosity can be measured using a rotational viscometer.

A feature of the heat conductive silicone grease composition of the present invention is its grease-like nature, and the composition should exhibit a grease-like state at least across the temperature range from −40 to 120° C.

### [Thermal Resistance]

Furthermore, the thermal resistance at 25° C. of a heat conductive silicone grease composition of the present invention, measured using a laser flash method, is preferably not more than 30 mm²·K/W, and is even more preferably 15 mm²·K/W or less. If the thermal resistance is within this range, then the composition of the present invention is able to efficiently dissipate the heat generated by a heat-generating body into a heat-radiating component, even in those cases where the heat-generating body has a large heat value. Measurement of the thermal resistance using a laser flash method can be conducted in accordance with ASTME 1461.

### [Composition Preparation]

A heat conductive silicone grease composition of the present invention can be prepared by mixing together the above components using a mixing device such as a dough mixer (kneader), a gate mixer, or a planetary mixer. A composition prepared in this manner exhibits a dramatically improved thermal conductivity, as well as favorable levels of workability, durability, and reliability.

### [Applications for the Composition]

A heat conductive silicone grease composition of the present invention is applied to heat-generating bodies and/or heat-radiating bodies. Examples of suitable heat-generating bodies include general power sources; electronic equipment such as power transistors for power sources, power modules, thermistors, thermocouples, and temperature sensors; and heat-generating electronic components including integrated circuits such as LSI and CPU circuits. Examples of suitable heat-radiating bodies include heat-radiating components such as heat spreaders and heat sinks, heat pipes, and heat-radiating plates. Application of the composition can be conducted by screen printing. Screen printing may be conducted using a metal mask or a screen mesh or the like. By applying a coating of a composition of the present invention between a heat-generating body and a heat-radiating body, heat can be transmitted efficiently from the heat-generating body into the heat-radiating body, meaning the heat can be effectively dissipated away from the heat-generating body.

### EXAMPLES

As follows is a more detailed description of the present invention using a series of synthesis examples, examples and comparative examples, although the present invention is not limited by the examples presented below.

Organosilicon compounds of the component (B) of the present invention were synthesized in the manner described below.

### Synthesis Example 1

A 1 liter round-bottom separable flask with a 4-necked separable cover was fitted with a stirrer, a thermometer, a Graham condenser and a dropping funnel. The separable flask was then charged with 250.0 g (1.2 mols) of 1,1,3,3,5,5-hexamethyltrisiloxane, and the temperature was raised to 70° C. Once this temperature had been reached, 0.6 g of a 2% by mass 2-ethylhexanol solution of chloroplatinic acid was added, and the resulting mixture was stirred at 70° C. for 30 minutes. Subsequently, 88.9 g (0.6 mols) of trimethoxyvinylsilane was added dropwise over a one hour period with the temperature held at 70 to 80° C., thereby initiating a reaction. Following completion of this dropwise addition, the reaction was continued with the temperature held at 70 to 80° C. During the reaction, the unreacted trimethoxyvinylsilane was refluxed. The progress of the reaction was tracked by gas chromatography, and the point where the chromatographic peak for trimethoxyvinylsilane disappeared was deemed to represent the completion of the reaction, and heating was stopped at this point. Following completion of the reaction, the interior of the separable flask was evacuated to a state of reduced pressure, and the residual 1,1,3,3,5,5-hexamethyltrisiloxane was removed, yielding a product solution. This solution was purified by distillation, yielding 200.2 g (0.56 mols, yield: 56%) of the target product, 1-trimethoxysilylethyl-1,1,3,3,5,5-hexamethyltrisiloxane (13).

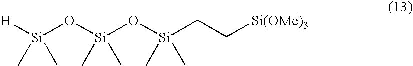

The above compound was identified by ²⁹Si-NMR and ¹H-NMR. ²⁹Si-NMR (C₆D₆): δ 8.33 to 7.82 ppm (CH₂SiMe₂O—), −7.23 to −7.51 ppm (HSiMe₂O—), −19.73 to −20.24 ppm (—OSiMe₂O—), −42.56 to −42.97 ppm (Si(OMe)₃);

¹H-NMR (CDCl₃): δ 4.70 to 4.66 ppm (m, 1H, HSi), 3.56 ppm (s, 9H, Si(OCH₃)₃), 1.09 to 0.56 ppm (m, 4H, Si(CH₂)₂Si), 0.17 to 0.02 ppm (m, 18H, Si(CH₃)₂O).

### Synthesis Example 2

A 1 liter round-bottom separable flask with a 4-necked separable cover was fitted with a stirrer, a thermometer, a Graham condenser and a dropping funnel. The separable flask was then charged with 235.6 g (1.2 mols) of 1-tetradecene, and the temperature was raised to 70° C. Once this temperature had been reached, 0.6 g of a 2% by mass 2-ethylhexanol solution of chloroplatinic acid was added, and the resulting mixture was stirred at 70° C. for 30 minutes. Subsequently, 356.71 g (1.0 mols) of the 1-trimethoxysilylethyl-1,1,3,3,5,5-hexamethyltrisiloxane obtained in the synthesis example 1 was added dropwise over a two hour period, thereby initiating a reaction. Following completion of this dropwise addition, the reaction was continued with the temperature held at 70 to 80° C. During the reaction, the unreacted 1-trimethoxysilylethyl-1,1,3,3,5,5-hexamethyltrisiloxane was refluxed. The progress of the reaction was tracked by gas chromatography, and the point where the chromatographic peak for 1-trimethoxysilylethyl-1,1,3,3,5,5-hexamethyltrisiloxane disappeared was deemed to represent the completion of the reaction, and heating was stopped at this point. Following completion of the reaction, the interior of the separable flask was evacuated to a state of reduced pressure, and the residual 1-tetradecene was removed, yielding an oily product. This oily product was purified with activated carbon, yielding 492.2 g (0.9 mols, yield: 89%) of the target product, 1-tetradecanyl-3-trimethoxysilylethyl-1,1,3,3,5,5-hexamethyltrisiloxane (14).

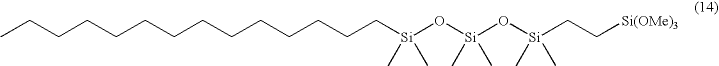

The above compound was identified by ²⁹Si-NMR and ¹H-NMR.

²⁹Si-NMR (C₆D₆): δ 7.95 to 6.93 ppm (CH₂SiMe₂, OSiMe₂CH₂), −21.39 to −21.89 ppm (—OSiMe₂O—), −42.53 to −42.90 ppm (Si(OMe)₃);

¹H-NMR (CDCl₃): δ 3.56 ppm (s, 9H, Si(OCH₃)₃), 1.24 to 0.48 ppm (m, 33H, Si(CH₂)₂S₁, CH₂, CH₃), 0.13 to 0.00 ppm (m, 18H, Si(CH₃)₂O).

### Synthesis Example 3

A 1 liter round-bottom separable flask with a 4-necked separable cover was fitted with a stirrer, a thermometer, a Graham condenser and a dropping funnel. The separable flask was then charged with 537.3 g (4.0 mols) of 1,1,3,3-tetramethyldisiloxane, and the temperature was raised to 70° C. Once this temperature had been reached, 1.0 g of a 2% by mass 2-ethylhexanol solution of chloroplatinic acid was added, and the resulting mixture was stirred at 70° C. for 30 minutes. Subsequently, 296.5 g (2.0 mols) of trimethoxyvinylsilane was added dropwise over a two hour period with the temperature held at 70 to 80° C., thereby initiating a reaction. Following completion of this dropwise addition, the reaction was continued with the temperature held at 70 to 80° C. During the reaction, the unreacted trimethoxyvinylsilane was refluxed. The progress of the reaction was tracked by gas chromatography, and the point where the chromatographic peak for trimethoxyvinylsilane disappeared was deemed to represent the completion of the reaction, and heating was stopped at this point. Following completion of the reaction, the interior of the separable flask was evacuated to a state of reduced pressure, and the residual 1,1,3,3-tetramethyldisiloxane was removed, yielding a product solution. This solution was purified by distillation, yielding 339.1 g (1.2 mols, yield: 60%) of the target product, 1-trimethoxysilylethyl-1,1,3,3-tetramethyldisiloxane (15).

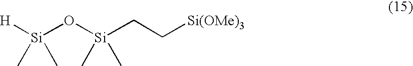

The above compound was identified by ²⁹Si-NMR and ¹H-NMR.

²⁹Si-NMR(C₆D₆): δ 10.19 to 9.59 ppm (CH₂SiMe₂O—), −6.88 to −7.50 ppm (HSiMe₂O—), −42.62 to −43.06 ppm (Si(OMe)₃);

¹H-NMR (CDCl₃): δ 4.66 to 4.59 ppm (m, 1H, HSi), 3.52 to 3.48 ppm (m, 9H, Si(OCH₃)₃), 1.04 to 0.48 ppm (m, 4H, Si(CH₂)₂Si), 0.12 to 0.01 ppm (m, 12H, Si(CH₃)₂O).

### Synthesis Example 4

A 1 liter round-bottom separable flask with a 4-necked separable cover was fitted with a stirrer, a thermometer, a Graham condenser and a dropping funnel. The separable flask was then charged with 202.0 g (1.2 mols) of 1-dodecene, and the temperature was raised to 70° C. Once this temperature had been reached, 0.70 g of a 2% by mass 2-ethylhexanol solution of chloroplatinic acid was added, and the resulting mixture was stirred at 70° C. for 30 minutes. Subsequently, 282.6 g (1.0 mols) of the 1-trimethoxysilylethyl-1,1,3,3-tetramethyldisiloxane obtained in the synthesis example 3 was added dropwise over a two hour period, thereby initiating a reaction. Following completion of this dropwise addition, the reaction was continued with the temperature held at 70 to 80° C. During the reaction, the unreacted 1-trimethoxysilylethyl-1,1,3,3-tetramethyldisiloxane was refluxed. The progress of the reaction was tracked by gas chromatography, and the point where the chromatographic peak for 1-trimethoxysilylethyl-1,1,3,3-tetramethyldisiloxane disappeared was deemed to represent the completion of the reaction, and heating was stopped at this point. Following completion of the reaction, the interior of the separable flask was evacuated to a state of reduced pressure, and the residual 1-dodecene was removed, yielding an oily product. This oily product was purified with activated carbon, yielding 405.8 g (0.9 mols, yield: 90%) of the target product, 1-dodecanyl-3-trimethoxysilylethyl-1,1,3,3-tetramethyldisiloxane (16).

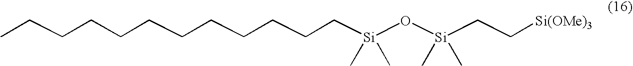

The above compound was identified by ²⁹Si-NMR and ¹H-NMR.

²⁹Si-NMR (C₆D₆): δ 7.85 to 6.82 ppm (CH₂SiMe₂O), −42.52 to −42.81 ppm (Si(OMe)₃);

¹H-NMR (CDCl₃): δ 3.55 ppm (s, 9H, Si(OCH₃)₃), 1.26 to 0.50 ppm (m, 29H, CH₃, CH₂), 0.09 to 0.01 ppm (m, 12H, Si(CH₃)₂O).

### Examples 1 to 7, Comparative Examples 1 to 4

First, each of the components required to form compositions of the present invention were prepared.

### (A) Organopolysiloxane

### A-1: an organopolysiloxane with a kinematic viscosity of 220 mm²/s, represented by the formula shown below.

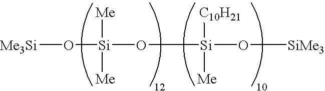

### A-2: an organopolysiloxane with a kinematic viscosity of 500 mm²/s, represented by the formula shown below.

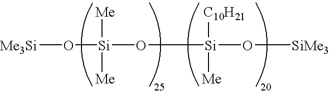

### (B) Wetter

### B-1: an organopolysiloxane represented by the formula shown below.

Me₃SiO(SiMe₂O)₃₀Si(OMe)₃

### B-2: an alkoxysilane represented by the formula shown below.

C₁₀H₂₁Si(OCH₃)₃

### B-3: an organosilicon compound (obtained in the synthesis example 2), represented by the formula shown below.

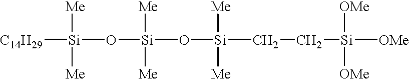

### B-4: an organosilicon compound (obtained in the synthesis example 4), represented by the formula shown below.

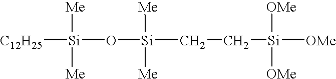

### (C) Heat Conductive Filler

C-1: aluminum powder (average particle size: 10.0 μm, the fraction that passed through a mesh size of 32 μm prescribed in JIS Z 8801-1)
C-2: aluminum powder (average particle size: 1.5 μm, the fraction that passed through a mesh size of 32 μm prescribed in JIS Z 8801-1)
C-3: alumina powder (average particle size: 10.0 μm, the fraction that passed through a mesh size of 32 μm prescribed in JIS Z 8801-1)
C-4: alumina powder (average particle size: 0.7 μm, the fraction that passed through a mesh size of 32 μm prescribed in JIS Z 8801-1)
C-5: zinc oxide powder (average particle size: 1.0 μm, the fraction that passed through a mesh size of 32 μm prescribed in JIS Z 8801-1)

The average particle size values for the various components (C) represent volume-based cumulative average particle size values measured using a particle size analyzer Microtrac MT3300EX, manufactured by Nikkiso Co., Ltd.

### (D) Volatile Solvent capable of Dispersing or Dissolving A-2 and B-3

### D-1: ISOSOL (a registered trademark)-400 (a product name for an isoparaffin-based solvent with a boiling point of 210 to 254° C., manufactured by Nippon Petrochemicals Co., Ltd.)

### [Method of Production]

The components (A) through (D) were mixed together in the ratios shown below, thereby forming compositions of examples 1 to 7, and comparative examples 1 to 4. In other words, the components (A) through (C) were combined in a 5 liter planetary mixer (manufactured by Inoue Manufacturing Co., Ltd.) using the ratios (parts by volume) shown in Table 1 and Table 2, and in each case the resulting mixture was mixed for one hour at 70° C. The mixture was then cooled to room temperature. In the composition that includes the component (D), the component (D) was added to the cooled mixture using the blend quantity shown in Table 1, and was then mixed thoroughly to generate a uniform mixture.

### [Test Methods]

The properties of the prepared compositions were measured using the test methods described below. The results are shown in Table 1 and Table 2.

### [Measurement of Viscosity]

Each of the prepared compositions was allowed to stand for 24 hours in a constant-temperature chamber at 25° C., and the viscosity (the initial viscosity) was then measured at a rotational velocity of 10 rpm using a viscometer (product name: Spiral Viscometer PC-1TL, manufactured by Malcom Co., Ltd.).

Following measurement of the initial viscosity, the composition was left to stand at 125° C. for 500 hours, and the viscosity of the composition was then re-measured using the same viscometer.

### [Measurement of Thermal Conductivity]

Each of the prepared compositions was poured into a mold with a thickness of 3 cm, a kitchen wrap was used to cover the composition, and the thermal conductivity of the composition was then measured using a thermal conductivity meter (product name: QTM-500) manufactured by Kyoto Electronics Manufacturing Co., Ltd.

### [Measurement of Thermal Resistance]

### <Test Piece Preparation>

A layer of the composition with a thickness of 75 μm was sandwiched between two circular aluminum plates of diameter 12.6 mm and thickness 1 mm, and preparation of the test piece was then completed by applying a pressure of 0.15 MPa at 25° C. for a period of 60 minutes.

### <Measurement of Thickness>

The thickness of each test piece was measured using a micrometer (manufactured by Mitsuyo Co., Ltd.), and the thickness of the composition layer was then calculated by subtracting the known thickness of the two aluminum plates.

### <Measurement of Thermal Resistance>

For each of the test pieces described above, the thermal resistance of the composition (units: mm²·K/W) was measured at 25° C., using a thermal resistance measurement device that employed a laser flash method (LFA447 NanoFlash, a xenon flash analyzer manufactured by Netzch Group).

TABLE 1

| | | | Example | | | | | | |
|---|---|---|---|---|---|---|---|---|---|
| | Name of Component | | 1 | 2 | 3 | 4 | 5 | 6 | 7 |
| Composition Ratio | Component (A) | A-1 | — | 100.0 | — | — | — | — | — |
| (parts by volume) | | A-2 | 100.0 | — | 100.0 | 100.0 | 100.0 | 100.0 | 100.0 |
| | Component (B) | B-3 | 6.6 | 6.6 | 15.0 | — | 5.5 | 6.6 | 6.6 |
| | | B-4 | — | — | — | 6.6 | — | — | — |
| | Component (C) | C-1 | 180.4 | 180.2 | 180.2 | 180.2 | — | 257.5 | 180.2 |
| | | C-2 | 77.3 | 77.2 | 77.2 | 77.2 | — | 110.3 | 77.2 |
| | | C-3 | — | — | — | — | 258.2 | — | — |
| | | C-4 | — | — | — | — | 28.7 | — | — |
| | | C-5 | 31.1 | 31.0 | 31.0 | 31.0 | 29.5 | 44.4 | 31.0 |
| | Component (D) | D-1 | — | — | — | — | — | — | 10.0 |

| | | | | | | | |
|---|---|---|---|---|---|---|---|
| Initial viscosity (Pa · s) | 112 | 100 | 85 | 105 | 240 | 498 | 98 |
| Viscosity (Pa · s) following exposure to high | 117 | 104 | 90 | 112 | 250 | — | 116 |
| temperature conditions (125° C. for 500 hours) | | | | | | | |
| Thermal conductivity (W/(m · K)) | 4.0 | 3.9 | 3.5 | 4.1 | 3.2 | 5.8 | 3.8*¹⁾ |
| Thickness (μm) | 28 | 30 | 28 | 28 | 32 | 33 | 36*¹⁾ |
| Thermal resistance (mm² · K/W) | 9.4 | 10.1 | 10.6 | 9.0 | 12.1 | 6.5 | 12.0*¹⁾ |

*¹⁾Measured following volatilization of ISOSOL

TABLE 2

| | | | Comparative Example | | | |
|---|---|---|---|---|---|---|
| | Name of Component | | 1 | 2 | 3 | 4 |
| Composition | Component (A) | A-2 | 100.0 | 100.0 | 100.0 | 100.0 |
| Ratio (parts | Component (B) | B-1 | — | — | 6.6 | — |
| by volume) | | B-2 | — | — | — | 6.6 |
| | | B-3 | 6.6 | 6.6 | — | — |
| | Component (C) | C-1 | 1785.6 | 16.6 | 257.5 | 180.4 |
| | | C-2 | 765 | 7.1 | 110.3 | 77.3 |
| | | C-5 | 307.5 | 2.9 | 44.4 | 31.1 |

| | | | | |
|---|---|---|---|---|
| Initial viscosity (Pa · s) | *²⁾ | 10 | *²⁾ | 90 |
| Viscosity (Pa · s) following | — | — | — | 176 |
| exposure to high temperature | | | | |
| conditions (125° C. for 500 hours) | | | | |
| Thermal conductivity (W/(m · K)) | — | — | — | 4.0 |
| Thickness (μm) | — | 28 | — | 30 |
| Thermal resistance (mm² · K/W) | — | 62 | — | 9.3 |

*²⁾The composition could not be converted to paste form, even when mixed using a mixer.

What is claimed is:

1. A heat conductive silicone grease composition, comprising:
(A) 100 parts by volume of an organopolysiloxane with a kinematic viscosity at 25° C. within a range from 10 to 100,000 mm²/s, represented by an average composition formula (1) shown below:
R¹ₐSiO_{(4-a)/2} (1)
(wherein, R¹ represents identical or different, unsubstituted or substituted monovalent hydrocarbon groups of 1 to 18 carbon atoms, and a represents a number within a range from 1.8 to 2.2),
(B) 0.1 to 50 parts by volume of an organosilicon compound represented by a general formula (2) shown below: 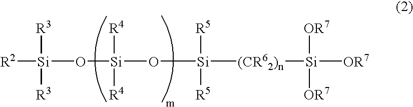
(wherein, R² represents an unsubstituted or substituted alkyl group, alkenyl group or aryl group, each R³ represents, independently, an unsubstituted or substituted alkyl group, alkenyl group or aryl group, R⁴ and R⁵ each represent identical or different unsubstituted or substituted monovalent hydrocarbon groups, each R⁶ represents, independently, a hydrogen atom, or an unsubstituted or substituted monovalent hydrocarbon group, each R⁷ represents, independently, an unsubstituted or substituted alkyl group, alkoxyalkyl group, alkenyl group or acyl group, m represents an integer from 0 to 4, and n represents an integer from 2 to 20), and
(C) 100 to 2,500 parts by volume of a heat conductive filler.

2. The composition according to claim 1, wherein a number of carbon atoms within R² is within a range from 6 to 30, and numbers of carbon atoms within R³, R⁴ and R⁵ are within a range from 1 to 8.

3. The composition according to claim 1, wherein said component (B) is 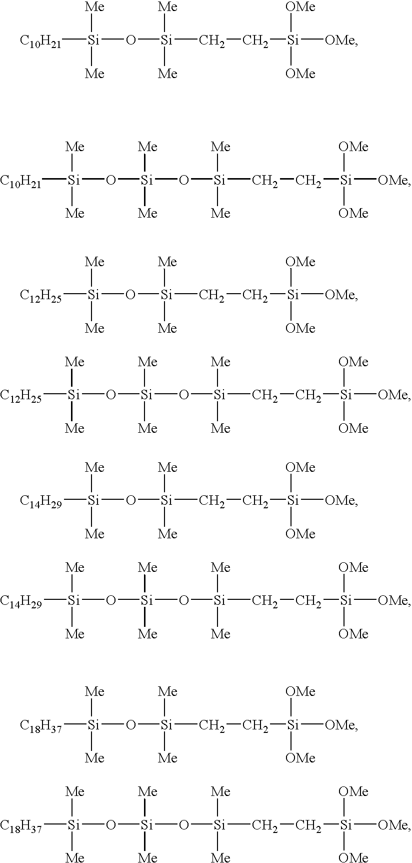
(wherein, Me represents a methyl group)
or combination thereof.

4. The composition according to claim 1, wherein said component (C) is aluminum, silver, copper, nickel, zinc oxide, alumina, silicon oxide, magnesium oxide, aluminum nitride, boron nitride, silicon nitride, silicon carbide, diamond, graphite, carbon nanotubes, metallic silicon, carbon fiber, fullerene, or a combination thereof, and an average particle size of said component (C) is within a range from 0.1 to 50 μm.

5. The composition according to claim 1, wherein a viscosity of the composition at 25° C. is not greater than 1,000 Pa·s.

6. The composition according to claim 1, wherein a thermal resistance of the composition at 25° C., measured using a laser flash method, is not greater than 30 mm²·K/W.

7. The composition according to claim 1, further comprising:
(D) not more than 100 parts by volume of a volatile solvent capable of dispersing or dissolving said components (A) and (B), per 100 parts by volume of said component (A).

8. The composition according to claim 7, wherein said component (D) is toluene, xylene, acetone, methyl ethyl ketone, cyclohexane, n-hexane, n-heptane, butanol, isopropanol, isoparaffin-based solvents, or a combination thereof.

9. A method for dissipating heat generated by a heat-generating body into a heat-radiating body, comprising the steps of:
applying the composition according to claim 1 to a surface of said heat-generating body, and
mounting said heat-radiating body on said applied composition to sandwich said composition between said heat-generating body and said heat-radiating body, thereby dissipating said heat into said heat-radiating body.
